(19) United States
(12) Patent Application Publication
(10) Pub. No.: US 2004/0125770 A1
(43) Pub. Date: Jul. 1, 2004

(54) Method and apparatus for transferring state information between communication networks

(76) Inventors: Randall Evans Pitt, Batavia, IL (US); Ruihua Zhang, Naperville, IL (US)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/335,562

(22) Filed: Dec. 31, 2002

(51) Int. Cl. H04Q 7/00

(52) U.S. Cl. 370/331; 370/436

(57) ABSTRACT

This invention relates to a method and apparatus for transferring state information between second generation (2G) and third generation (3G) communication networks. More particularly, the invention is directed to a system for allowing the transfer of mobile state information—such as Mobility Management (MM) information, and Packet Data Protocol (PDP) information, Customized Applications for Mobile Enhanced Logic (CAMEL) information and charging/billing information—between 2G (GPRS—General Packet Radio Service) and 3G (UMTS—Universal Mobile Telecommunication Service) systems.

### BACKGROUND OF THE INVENTION

This invention relates to a method and apparatus for transferring state information between second generation (2G) and third generation (3G) communication networks. More particularly, the invention is directed to a system for allowing the transfer of mobile state information—such as Mobility Management (MM) information, Packet Data Protocol (PDP) information, Customized Applications for Mobile Enhanced Logic (CAMEL) information and charging/billing information—between 2G (GPRS—General Packet Radio Service) and 3G (UMTS—Universal Mobile Telecommunication Service) systems.

While the invention is particularly directed to the art of transferring state information between 2G and 3G networks, and will be thus described with specific reference thereto, it will be appreciated that the invention may have usefulness in other fields and applications. For example, the invention may be used in the transfer of other types of data between these networks or in the transfer of data between different generations of networks.

By way of background, the technology relating to wireless communications networks is ever-evolving. For example, communication networks are now implementing and/or will be implementing second generation (2G) and third generation (3G) technology. However, it is not practical to replace all of the communication infrastructure and existing networks at the same time upon evolution to a new technology. As such, there are and will be many circumstances where second generation technology will interface with third generation technology. These interfaces are generally addressed in the various standards and preferred implementations of the technologies. However, difficulties nonetheless have arisen and will continue to arise.

For example, such difficulties occur when a mobile station moves from one geographic area that is covered by one type of technology (e.g. 2G) to another geographic area that is covered by another type of technology (e.g. 3G). To illustrate, referring now to FIG. 1, an overall network 10 is shown. In the network 10, a mobile station 12 is positioned at a location A. At location A, the mobile station 12 communicates with a base station control (BSC) unit 14, which in turn communicates with a second generation (2G) Serving General packet radio service Support Node (SGSN) 16. The 2G SGSN 16 further communicates with a Gateway General Packet Radio Service Support Node (GGSN) 18 which in turn communicates with the rest of the world, i. e. packet data network 20. It is significant to note that the interface between base station control 14 and 2G SGSN 16, designated by Gb, uses frame relay technology. Moreover, this interface transfers control information in the control plane and user or subscriber data in the user plane over one virtual circuit.

The same mobile station 12, when at location B, communicates with a Radio Network Controller (RNC) 22. The Radio Network Controller (RNC) 22 interfaces with a third generation (3G) Serving General packet radio service Support Node (3G SGSN) 24. The 3G SGSN 24 is in communication with the support node 18. Of particular note, the interface between the RNC 22 and the 3G SGSN 24, designated as Iu-PS, uses asynchronous transfer mode (ATM) technology and it utilizes separate virtual circuits for control information in the control plane and user or subscriber data in the user plane.

Difficulties arise when mobile station 12 moves, for example, from location A to location B. That is, when a mobile station moves from the control of one network to another, a Routing Area Update (RAU) is necessary and numerous items of information must likewise be moved from, for example, 2G SGSN 16 to 3G SGSN 24. However, known manners for doing so require undesired messaging between these components. This additional messaging, particularly as it relates to state information such as mobility management information (MM), packet data protocol information (PDP), and customized applications for mobile enhanced logic (CAMEL) information, results in an undue burden on the various network elements. The reason for the signaling is that information present on 2G SGSN 16 has to be provided to 3G SGSN 24, if 3G SGSN 24 is to serve the mobile 12. Some information is passed directly, using GPRS Tunneling Protocol (GTP) messages. Mobility management information is obtained by signaling with the Home Location Register (HLR). In addition, network elements (e.g. HLR, GGSN, Short Message Services Center (SM-SC), etc. (not specifically shown)) that formerly could reach the mobile 12—through 2G SGSN 16—have to be provided with information to reach it through 3G SGSN 24. Of course, similar problems arise when the mobile station moves from the control of the 3G SGSN 24 to the 2G SGSN 16, as those of skill in the art will appreciate.

Therefore, a Serving GPRS Support Node (SGSN) that is able to support both the GPRS and UMTS in current packet data network services is desired. One known approach to accomplish this objective is to provide a fully integrated SGSN that would implement all functions required of both 2G and 3G systems. This reduces signaling, for example, to a minimum and is desirable when only technical considerations are taken into account. However, the cost of developing such a system is prohibitive. It is, by far, the most expensive approach because 2G and 3G processing is so different. There are 2G-specific and 3G-specific control functionalities that must be included. Moreover, the interfaces between the BSC 14 and corresponding SGSN 16 and those between the RNC 22 and the SGSN 34 are of different, incompatible forms.

The present invention contemplates a new and improved method and apparatus that addresses the above-referenced issues and others.

### SUMMARY OF THE INVENTION

A method and apparatus for transferring state information between second generation (2G) and third generation (3G) communication networks are provided.

In one aspect of the invention, the method comprises establishing an interface operative to perform signaling on a control plane between a first network and a second network, detecting movement of a mobile station between a first area corresponding to the first network and a second area corresponding to the second network and transferring state information from the first network to the second network on a private extension field of the control plane.

In another aspect of the invention, the apparatus comprises a first call processing unit associated with the first communication network, a second call processing unit associated with the second communication network and an interface between the first call processing unit and the second call processing unit, the interface operative to perform signaling on a control plane to transfer state information in an extension field of the control plane.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system to which the present invention could be applied;

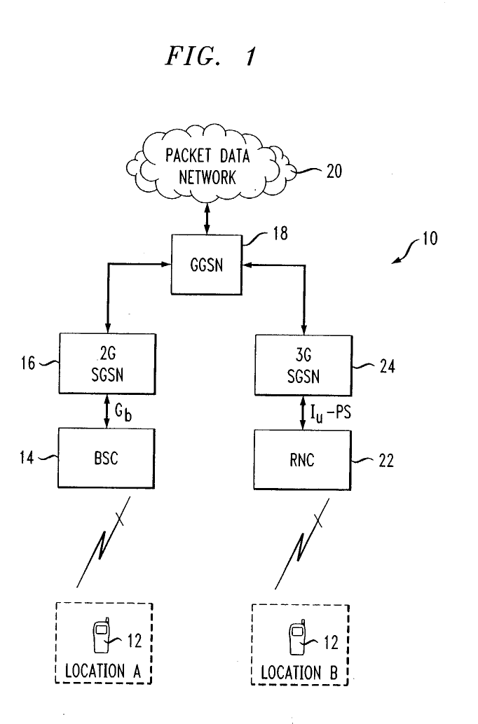

FIG. 2 is a block diagram illustrating an embodiment of and an environment for the present invention;

FIGS. 3(a)-3(d) are graphic representations of a form of data transferred according to the present invention; and,

FIG. 4 is a flowchart illustrating a method according to the present invention.

### DETAILED DESCRIPTION OF THE PREFERRED EMBODIMENTS

The present invention provides a method for implementing a state information transfer interface between independent 2G and 3G call processing units. The subject method makes use of a private extension field of a GTP-C protocol that may be implemented on both 2G GPRS and 3G UMTS system, as specified in 3GPP TS 29.060 (v3.14.0 (2002-09)), which is incorporated herein by reference. The use contemplated by the present invention is not provided for in the above-noted standard, however. The invention thus provides a low cost and elegant approach for software deployment.

More specifically, the current invention provides a method for transferring desired mobile state information between 2G GPRS and 3G UMTS call processing units, or entities, when the mobile station performs its air interface change from a 2G GPRS radio network to a 3G UMTS radio network. This, of course, typically occurs when the mobile station moves from one location—best covered by a 2G network—to another location—best covered by a 3G network. It may also occur when the mobile station moves from one location—best covered by a 3G network—to another location—best covered by a 2G network. In either case, this method utilizes an extension field identified in 3GPP TS 29.060, noted above, which specifies standard GTP-C messages for both 2G GPRS and 3G UMTS SGSN. Because the interface of the present invention is a new use of the standard specification, it provides an improvement over that which is currently known that minimizes the software development cost. That is, the invention herein contemplates utilizing the extension field in a different manner specified in the standard to avoid costly software re-development that might otherwise be necessary in the known approaches detailed above and other manners of developing unique private interface protocols.

One implementation of the present invention may be accomplished by adding additional UMTS processing elements and interfaces to an existing operational 2G GPRS system in a GPRS network, i. e. to form a combined 2G-3G SGSN system having a shared common SS7 gateway. When a Mobile Station (MS) moves from a 2G cell to a 3G cell, or vice-versa, within the coverage of the 2G-3G combined SGSN, the MS state information such as MM, PDP, and other parameters such as CAMEL-related information is thus transferred between the 2G and 3G call processing unit, so that the SS7 network is not aware of such intra 2G-3G combined SGSN changes. Thus, no new signaling messages related to a Routing Area Update (RAU) are generated to the SS7 link. As a result, as those of skill in the art will appreciate, the invention eliminates the need for certain messages that are recited in the standard, i.e. 3GPP TS 23.60 (v3.13.0 (2002-09)), which is incorporated herein by reference. For example, the invention eliminates the need for RAU messaging from the 2G or 3G SGSN to the HLR in these circumstances. The need for messages related to the CAMEL procedures, and charging messages from the old SGSN, is also eliminated. The need for messages that relate to optional updates to the circuit side (e.g. MSC) in this type of system is likewise eliminated. Again, the elimination of this undesired messaging results in advantages for the network. For example, when a mobile moves between 2G and 3G radio networks when the present invention is implemented, the signaling load is reduced and the performance of the network is enhanced compared to that of separate 2G and 3G SGSNs.

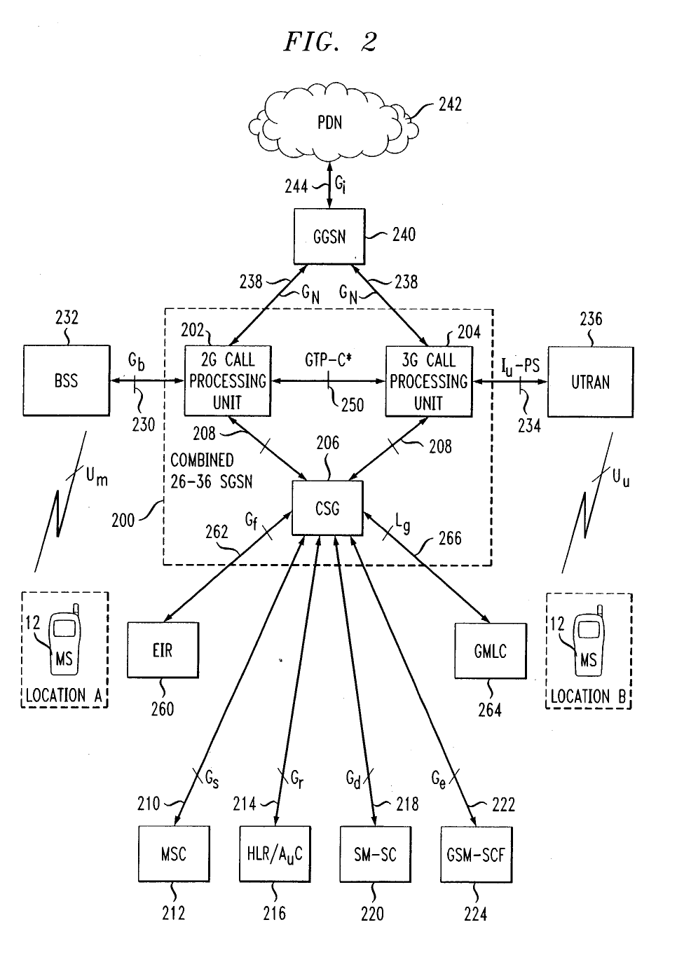

Referring now to the drawings wherein the showings are for purposes of illustrating the preferred embodiments of the invention only and not for purposes of limiting same, FIG. 2 provides a view of a system implementing the present invention. As shown, a combined 2G-3G Serving GPRS Support Node (SGNS) system 200 is a network element or entity that has two stand-alone SGSN call processing units 202 and 204. On the radio network side, the 2G unit 202 handles user data and control signaling that is related to 2G GPRS radio network services. The 3G unit 204 handles user data and control signaling that is related to 3G UMTS radio network services.

A Common Signaling Gateway (CSG) 206, as shown in FIG. 2, communicates with the external SS7 network and both 2G and 3G call processing units through an internal interface 208. Such a combined 2G-3G SGSN may be evolved from a 2G GPRS SGSN system to which the 3G SGSN functionalities are added to serve subscribers who need 3G UMTS services. Likewise, a combined 2G-3G SGSN may be evolved from a 3G UMTS SGSN system to which 2G SGSN functionalities are added.

The CSG 206 may use Gs interface 210 to communicate with the Mobile Switching Center (MSC) 212. A Gr interface 214 is used to communicate with the Home Location Register (HLR) 216 which provides a database containing both 2G and 3G service subscription information and an Authentication Center (AuC) that stores data that allows the SGSN to authenticate the IMSI and also allows the radio communication path to the mobile station to be encrypted. A Gd interface 218 is used to communicate with the Short Message Service—Service Center (SMS-SC) 220, and a Ge interface 222 is used to communicate with the GSM Service Control Function (GSM SCF) 224. The CSG, thus, has a single Point Code (PC) representation to the SS7 network for both the 2G and 3G Call Processing Units.

Also shown in FIG. 2 is Gb interface 230 that allows for communication between call processing unit 202 and Base Station System (BSS) 232. Likewise, Iu-PS interface 234 allows for communication between call processing unit 204 and UMTS Terrestrial Radio Access Network (UTRAN) 236.

A Gateway GPRS Support Node (GGSN) 240 is shown as communicating with call processing units 202 and 204 by way of Gn interfaces 238. The GGSN 240, of course, communicates with rest of the world, i.e. packet data network (PDN) 242, through Gi interface 244. In addition, the CSG 206 communicates with an Equipment Identity Register (EIR) through Gf interface 262 and a Gateway Mobile Location Center 264 through Lg interface 266.

The mobile station 12 is shown at both locations A and B in FIG. 2. As will be appreciated, difficulties that are addressed by the present invention arise when the mobile station 12 moves from location A to location B, or from location B to location A. It should also be noted that the mobile station 12 communicates with BSS 232 through air interface Um and communicates with UTRAN 236 through air interface Uu. It will be understood that the mobile station 12 does not use both interfaces at the same time.

The interface between 2G and 3G call processing units, i.e. GTP-C* interface 250, as seen within the 2G-3G combined SGSN system 200, enables Mobility Management (MM) information, Packet Data Protocol (PDP) information and other mobile state information to be transferred internally between 2G and 3G call processing units whenever the mobile station 12 moves between 2G and 3G coverage, both types of coverage being within the coverage of the 2G-3G combined SGSN. This may occur as the mobile station moves from a 2G GPRS radio network to the 3G UMTS radio network, or vice versa. It should be understood that GTP-C* designation differentiates the system of the present invention, which utilizes the Optional Extension Field as described herein, from the designation GTP-C as recognized by the standard.

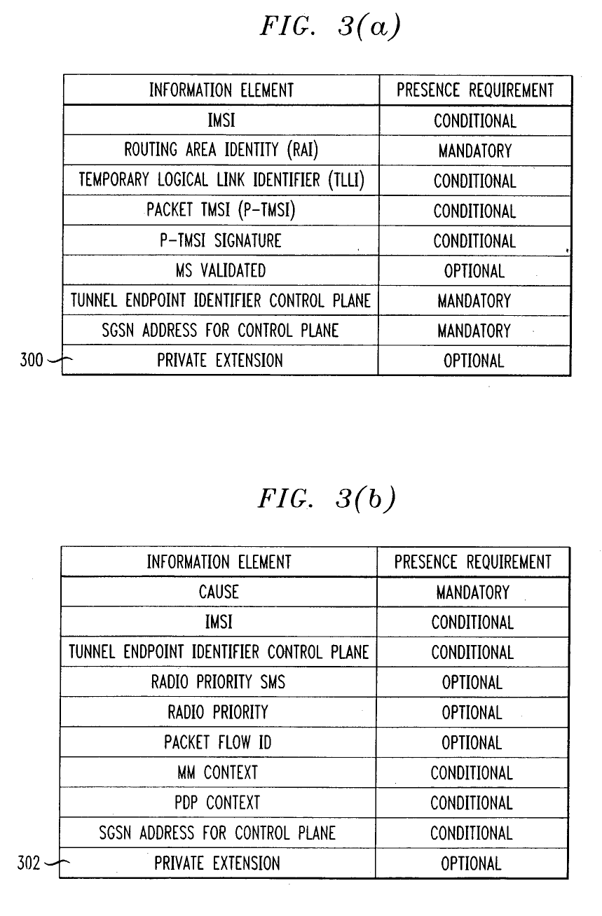

The method and apparatus (or system) of this invention make use of a private extension information element of the GPRS Tunneling Protocol-Control (GTP-C) interface 250. A GTP-C signaling message consists of the GTP-C header and subsequent information elements depending on the type of control plane message. There are three GTP-C messages that are used in normal RAUs and include the noted private information element: SGSN Context Request, SGSN Context Response, and SGSN Context Acknowledge. The elements of these message types are illustrated in FIG. 3(a), FIG. 3(b) and FIG. 3(c), respectively. Significantly, each of these types of messages has, as shown, one or more private extension fields such as 300, 302, and 304, respectively. Such a private extension field is illustrated in FIG. 3(d) and is defined in section 7.7.44 of 3GPP TS 29.060 (v3.14.0 (2002-09)). 3GPP TS 29.060 (v3.14.0 (2002-09)) is hereby incorporated by reference herein in its entirety. The private extension fields are provided in the standard to carry vendor specific information and include a Type area 312, Length area 314, Extension Identifier 316 and Extension Value area 318. The standard does not, however, provide for the use of the private extension field as contemplated herein.

In accord with the present invention, the MM and PDP context information are carried by the private extension information elements in above messages. Further, those private extension elements are utilized or implemented for storing other state information. In the case of CAMEL, for example, the volume trigger, and current byte count are parameters that are transferred to the destination call processing unit. Since the gsmSCF entity in the network will see only one visible CAMEL interface from the 2G-3G combined SGSN, the SS7 network will see no new RAU update messages as in the case of an inter-SGSN RAU in section 6.13 in the 3GPP TS 23.060. 3GPP TS 23.060 (v3.13.0 (2002-09)) is hereby incorporated by reference herein in its entirety. It should be understood that the precise software and/or hardware implementation of the invention in any given system will vary depending on the systems to which the invention is being applied and the objectives of the individual that is implementing the invention. For example, the state information may be encoded into the private extension field to maximize efficiency with respect to the number of bits, the manner in which the data is stored and the encoding and decoding schemes used.

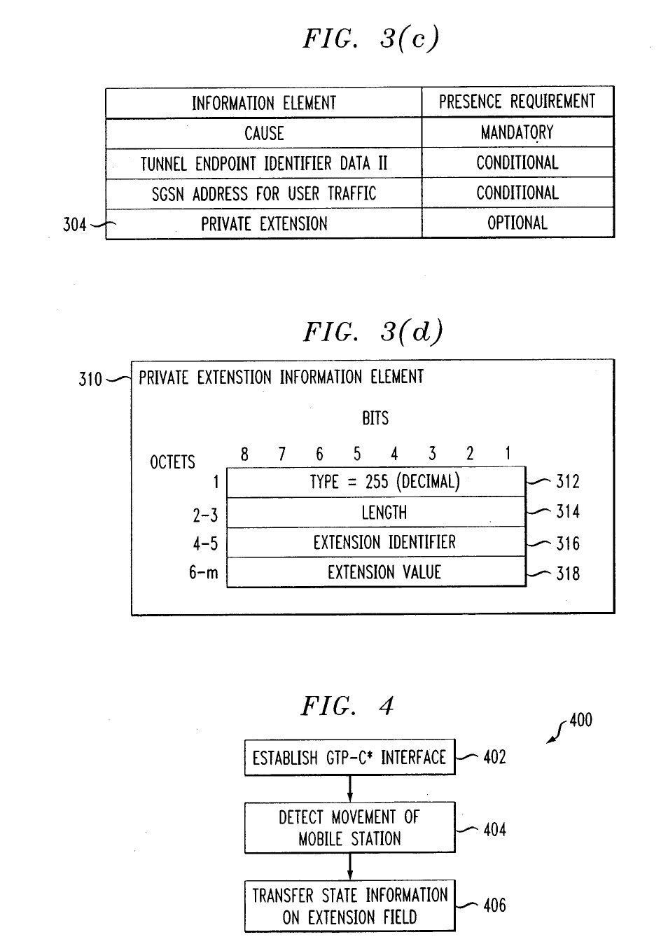

As to general operation, referring now to FIG. 4, a method 400 that is implemented in the combined 2G-3G SGSN 200 (FIG. 2) according to the present invention is illustrated. Initially, an appropriate interface on a control plane between first (e.g. 2G GPRS) and second (3G UMTS) networks is established (step 402). Of course, as indicated above, this interface is preferably a GTP-C* interface wherein the private extension field of the control plane is utilized to carry state information between call processing units (step 402). Next, the movement of a mobile station is detected by the SGSN 200 (step 404). It will be appreciated that this detection occurs using infrastructure, software and other network techniques that are well known to those skilled in the art. As those of skill in the art will appreciate, it is typically the mobile station itself that first recognizes the change in Routing Area and then initiates the 2G-3G change by sending a RAU request to the new SGSN which then initiates a RAU to the old SGSN so that the mobile station can be re-synchronized on the new system. In accord with the present invention, the mobile station performs those functions with the call processing units of the combined 2G-3G SGSN 200; however, an inter-SGSN RAU is not required. Upon such detection of the movement of the mobile station by the combined 2G-3G SGSN 200, the state information is transferred in the control plane on the extension field designated in step 402 (step 406). As a result of the transfer of the state information, important functions are transferred. For example, the servicing of the mobile station is transferred from one call processing unit to another, user data is processed by the new call processing unit, and short messages go through the new call processing unit. As noted above, the state information that is preferably transferred is MM information, PDP information, CAMEL information, and/or billing/charging information. It should also be understood, however, that a variety of other types of state information could be advantageously transferred as a function of the objectives of the network designer and/or resources available.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

Having thus described the invention, we hereby claim:

1. A method for providing an interface between communication networks, the method comprising steps of:
establishing an interface operative to perform signaling on a control plane between a first network and a second network;
detecting movement of a mobile station between a first area corresponding to the first network and a second area corresponding to the second network; and,
transferring state information from the first network to the second network on a private extension field of the control plane.

2. The method as set forth in claim 1 wherein the first network is a second generation communication network.

3. The method as set forth in claim 1 wherein the first network is a General Packet Radio Service (GPRS) communication network.

4. The method as set forth in claim 1 wherein the second network is a third generation communication network.

5. The method as set forth in claim 1 wherein the second network is a Universal Mobile Telecommunication Service (UMTS) communication network.

6. The method as set forth in claim 1 wherein the establishing of the interface comprises establishing an interface operative to perform the signaling on a General Packet Radio Service Tunneling Protocol-Control Plane (GTP-C) interface.

7. The method as set forth in claim 1 wherein the transferring of state information comprises transferring mobility management (MM) information.

8. The method as set forth in claim 1 wherein the transferring of state information comprises transferring packet data protocol (PDP) information.

9. The method as set forth in claim 1 wherein the transferring of state information comprises transferring Customized Applications for Mobile Enhanced Logic (CAMEL) information.

10. The method as set forth in claim 1 wherein the transferring of state information comprises transferring charging and billing information.

11. A support node system for providing an interface between a first communication network and a second communication network, the system comprising:
a first call processing unit associated with the first communication network;
a second call processing unit associated with the second communication network; and,
an interface between the first call processing unit and the second call processing unit, the interface operative to perform signaling on a control plane to transfer state information in an extension field of the control plane.

12. The system as set forth in claim 11 wherein the first network is a second generation communication network.

13. The system as set forth in claim 11 wherein the first network is a General Packet Radio Service (GPRS) communication network.

14. The system as set forth in claim 11 wherein the second network is a third generation communication network.

15. The system as set forth in claim 11 wherein the second network is a Universal Mobile Telecommunication Service (UMTS) communication network.

16. The system as set forth in claim 11 wherein the interface comprises a General Packet Radio Service Tunneling Protocol-Control Plane (GTP-C) interface.

17. The system as set forth in claim 11 wherein the state information comprises mobility management (MM) information.

18. The system as set forth in claim 11 wherein the state information comprises packet data protocol (PDP) information.

19. The system as set forth in claim 11 wherein the state information comprises Customized Applications for Mobile Enhanced Logic (CAMEL) information.

20. The system as set forth in claim 11 wherein the state information comprises charging and billing information.

21. The system as set forth in claim 11 wherein the system is a Serving General packet radio service Support Node (SGSN).

22. The system as set forth in claim 11 further comprising a Common Signaling Gateway (CSG) in communication with the first call processing unit and the second call processing unit.

23. A system for providing an interface between communication networks, the system comprising:
means for establishing an interface operative to perform signaling on a control plane between the a first network and a second network;
means for detecting movement of a mobile station between a first area corresponding to the first network and a second area corresponding to the second network; and,
means for transferring state information from the first network to the second network on a private extension field of the control plane.
